(19) United States
(12) Patent Application Publication
(10) Pub. No.: US 2007/0056532 A1
(43) Pub. Date: Mar. 15, 2007

(54) Woven chain

(76) Inventor: Neil Werde, Broomfield, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/229,267

(22) Filed: Sep. 15, 2005

(51) Int. Cl. A01K 27/00

(52) U.S. Cl. 119/864

(57) ABSTRACT

An animal control device. The device may include a chain having a cord or fabric woven along its length. The fabric may take the form of a rope, strip, batting, or other item softer and/or more resilient than the chain. The fabric may be made from a natural fiber, such as cotton or hemp, leather or animal hide, or a manmade material, such as polypropylene, neoprene, other rubbers or plastics. When a manmade material is used for the fabric, the material is generally at least somewhat resilient and/or flexible in order to adapt to motion of the chain. The fabric may be woven through each link in the chain, or only certain links.

### BACKGROUND OF THE INVENTION

1. Technical Field

The present invention relates generally to animal control devices, and more particularly to a chain including a fabric woven therethrough.

2. Background Art

Animals and man have enjoyed a mutually respectful relationship for many years. Domestication of animals, such as cats, dogs, and so forth, has become commonplace; many households include a pet of some sort.

Generally, such animals require some amount of daily exercise. A typical exercise for animals and their human companions is walking. When walking an animal, the person often restrains the animal with a leash. The leash may be attached to a collar encircling the animal's neck, for example. In this manner, the person may control the distance between him and the animal.

For particularly large or energetic animals, such as certain breeds of dogs, it is often desirable to provide additional incentive to curb the animal's motion, since the animal may pull repeatedly on the leash and/or pull the person off-balance. One example of a suitable device is a so-called “choke chain.” A choke chain generally takes the form of a chain attached to the leash and encircling the animal's neck in lieu of (or in addition to) a collar. One end of the choke chain is attached to the leash; the body of the chain passes through a hoop affixed to the other end of the chain. The choke chain thus forms a circle about the animal's neck with the length of the chain free to slide through the hoop. Thus, as the animal pulls against the leash, the chain may tighten about the animal's neck and curtail or cut off the animal's breathing.

Choke chains may also be used to train an animal. For example, the chain may be drawn taut when the animal performs an undesired action or fails to heed a command in order to provide negative feedback.

However, choke chains have certain disadvantages. For example, the chain may catch the animal's skin or hair between links as it draws taut, pinching or permanently harming the animal. Further, if the chain kinks, pressure across the length of the choke chain encircling the animal's throat may be unevenly distributed, thus causing increased pressure at certain points on the animal's neck. Further, choke chains are generally not aesthetically pleasing.

It will be apparent to those of ordinary skill in the art that the present invention may address one or more of the foregoing issues.

### SUMMARY OF THE INVENTION

Generally, one embodiment of the present invention may take the form of a chain for controlling an animal. The chain may be sized to fit around an animal's neck. Typically, at least one end (a “free end”) of the chain includes a hoop disposed thereon. In operation, the chain may encircle the animal's neck, with a leash end of the chain passing through the hoop. The leash end may then be connected to a leash. In this manner, drawing on the leash moves the chain through the hoop, tightening the chain around the animal's neck.

The chain may include a fabric, rope, or other at least partially flexible element (collectively, “fabric”) woven through the chain links. The fabric may, in some embodiments, be constructed of multiple interconnected elements. For example, the fiber may be made of multiple strands woven together in a rope-like fashion, or may be made of strips glued end-to-end. The fabric may have a decorative pattern displayed thereon for aesthetic appeal.

Another embodiment of the invention may take the form of an animal restraint device, including a chain comprising at least a first link and a second link, and a fabric woven between the at least two links.

Yet another embodiment of the invention may be an apparatus including a chain having a first end and a second end, the chain including at least three links, the first link defining a first interior aperture, the second link defining a second interior aperture, the third link defining a third interior aperture, a fabric woven through the first, second, and third interior apertures, the fabric being at least two strands woven together, a first hoop disposed at the first end, a second hoop disposed at the second end, and a leash attached to the first hoop.

Still another embodiment is a method for constructing an animal restraint device, including the operations of providing a chain having at least a first and a second link and weaving a fabric between the first and second links.

Various benefits and advantages of the present invention will be apparent to those of ordinary skill in the art upon reading this disclosure in its entirety.

### BRIEF DESCRIPTION OF THE FIGURES

FIG. 1 depicts an embodiment of the present invention in an operating position.

FIG. 2 depicts the embodiment of FIG. 1 in an exemplary operating environment.

FIG. 3A depicts a front view of the embodiment of FIG. 1.

FIG. 3B depicts a front view of the ends of the embodiment of FIG. 1.

FIG. 4 depicts a side view of the embodiment of FIG. 1.

FIG. 5 depicts a side view of the ends of the embodiment of FIG. 1.

FIG. 6A depicts a cross-sectional view of the embodiment of FIG. 1, taken along line 6-6 of FIG. 5

FIG. 6B depicts a close-up view of a portion of the embodiment of FIG. 1, showing the area in the dashed circle of FIG. 6A.

FIG. 7A depicts a cross sectional view similar to that of FIG. 6A, but of a second embodiment of the invention.

FIG. 7B depicts a close-up view of a portion of the embodiment of FIG. 7A, showing the area in the dashed circle of FIG. 7A.

### DETAILED DESCRIPTION

One embodiment of the present invention takes the form of an animal restraining device. The animal (or pet) restraint may be used, for example, as an animal collar. The embodiment may include a chain made from a one or more of a variety of materials, such as a metal, plastic, or composite. A ring or loop may be disposed at one or both ends of the chain. Generally, in operation the chain is fitted about the animal's neck with a first end of the chain passing through the loop (or a chain link) at the chain's free end. The first end, or fixed end, may be attached to a leash, rope, or other device. As the leash is pulled the chain slides through the loop or chain link, tightening around the animal's neck. The chain thus may cause discomfort in the animal or, in cases where significant force is applied, at least partially choke the animal. For this reason, the chain may be referred to as a “choke chain.”

The chain may have a cord or fabric woven along its length. Generally speaking, the fabric may take the form of a rope, strip, batting, or other item softer and/or more resilient than the chain. The fabric may be made from a natural fiber, such as cotton or hemp, leather or animal hide, or a manmade material, such as polypropylene, neoprene, other rubbers or plastics. When a manmade material is used for the fabric, the material is generally at least somewhat resilient and/or flexible in order to adapt to motion of the chain.

The fabric may be woven throughout the length of the chain, or across only a portion of the chain. Further, the fabric may be woven in and out of each link, or extend along the length of the chain in a different pattern. The fabric may be secured at one or both ends of the chain in order to maintain the relationship and/or position between fabric and chain.

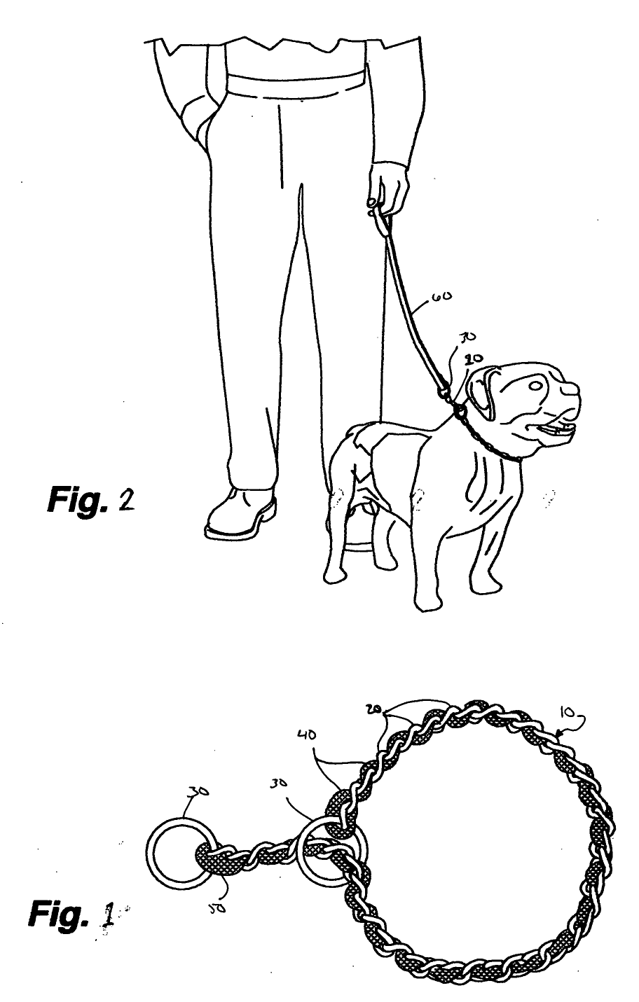

FIG. 1 depicts one embodiment of the present invention. A chain 10 is made of multiple links 20. One hoop 30 is disposed at each end of the chain. Alternative embodiments may place a hoop at only one end of the chain, or at neither end. Yet other alternative embodiments may replace one or both hoops 30 with snaps, hooks, eyelets, or other connectors. One or both hoops 30 are typically permanently affixed to the chain 10, although in alternative embodiments the hoop(s) may be removable.

As also shown in FIG. 1, a fabric 40 (here, a rope-like woven fabric) is disposed within the links of the chain 10. Generally speaking, the fabric 40 extends along the entirety of the chain, passing through the center of each link 20 in the chain. In alternative embodiments, the weave pattern of the fabric through the chain may vary. For example, the fabric 40 may be woven through every other or every third link 20 in certain embodiments.

Weaving the fabric 40 through the links 20 may provide certain benefits. For example, the fabric may reduce the tendency of the chain links to impact one another when the chain 10 is bent or shaken. Thus, the fabric 40 may reduce noise produced by motion of the chain 10. Further, because the fabric 40 overlays at least some of the chain link intersections (i.e., the points at which adjacent links pass through one another) on each side, the fabric may prevent an animal's skin, hair, or fur from getting caught or pinched between links 20. Thus, the embodiment may provide training benefits typically associated with a choke chain, such as deterring an animal from a particular course of action, but reduce unintentional pain inflicted on the animal.

As yet another possible benefit, the fabric 40 woven through the chain links 20 may serve to more uniformly distribute pressure caused by the tightening of the chain 10. Since the fabric 40 is typically a single strip of material or woven item, pressure generally is not focused upon any single point as the embodiment tightens around an animal's neck or other appendage. By contrast, a typical prior art choke chain may kink or twist at the intersection of two links, thus concentrating force or pressure.

FIG. 2 generally shows the embodiment in an exemplary operating environment. The hoop 30 may be attached to a leash 60, which may be held by a person walking, exercising, controlling, or otherwise interacting with the animal. The chain 10 extends from the hoop 30, passing about the animal's neck. (In some embodiments, the chain 10 may pass about the animal's torso, waist, leg, or other body part.) The As slack in the leash 60 is taken up, the free end of the chain 10 slides along the chain, such that the chain tightens around the animal's neck. The animal may experience discomfort from the tightening chain 10, thus curtailing the activity causing the chain to tighten.

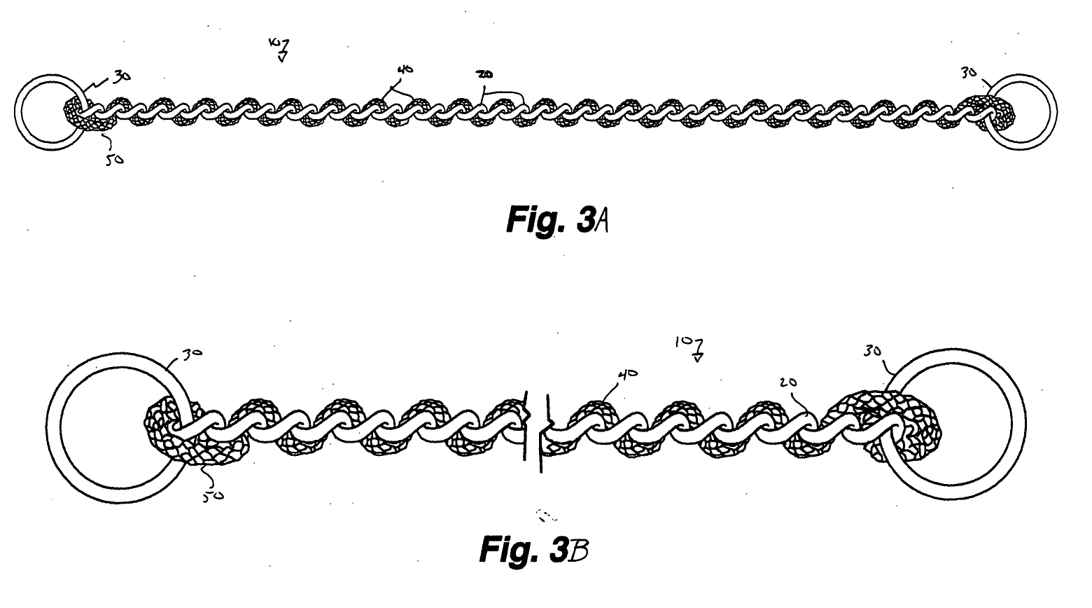

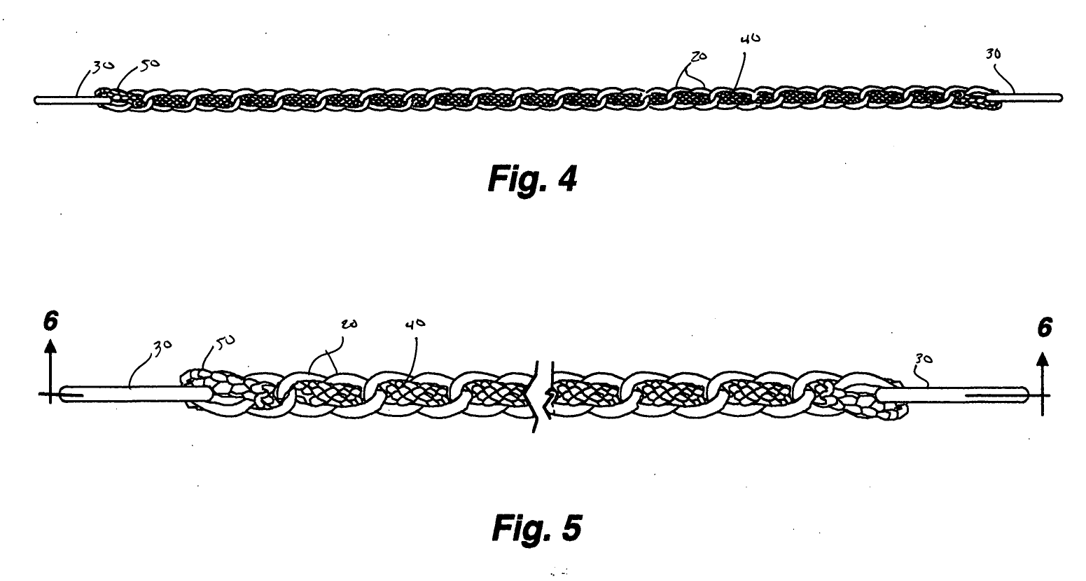

FIGS. 3A and 3B generally show the embodiment stretched taut between the two hoops 30. FIG. 3A depicts the fabric 40 passing through each loop 20 of the chain 10, as well as the end 50 of the fabric looped about the hoop 30. FIGS. 4 and 5 depict the embodiment from a view rotated 90 degrees from that of FIGS. 3A and 3B.

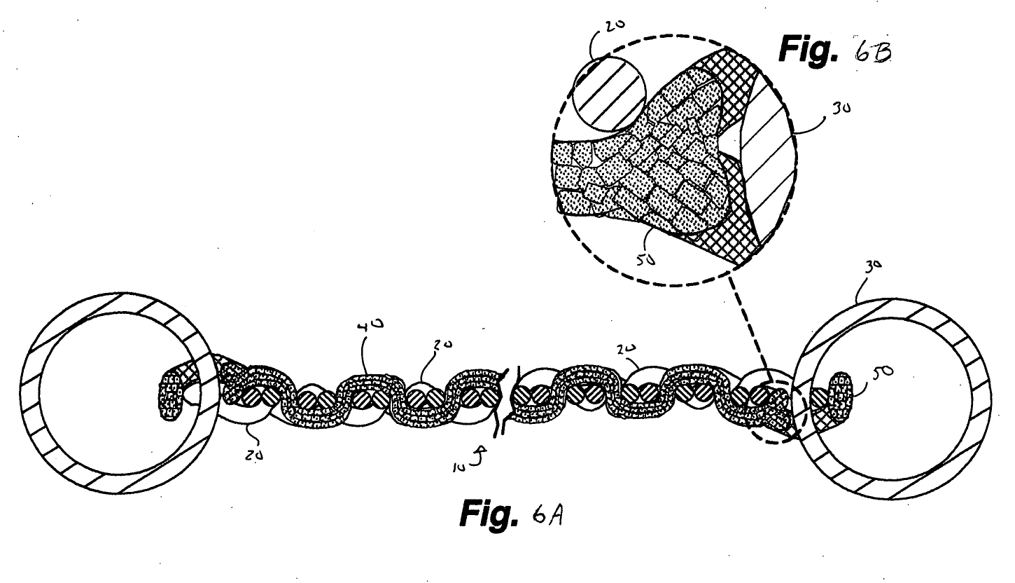

As shown in FIGS. 6A and 6B, the fabric 40 may be doubled about and attached to itself to maintain its relationship to the chain 10. The end 50 of the fabric 40 may be spliced into the fabric itself at some point, as shown in FIG. 6B. This is most common in embodiments employing a fabric made of individual strands woven together in a rope-like manner, but may be used in embodiments employing other fabrics. For example, the fabric 40 may be split at a point along its length to permit the end of the fabric to pass therethrough, effectively permitting the end of the fabric to be spliced into the body of the fabric.

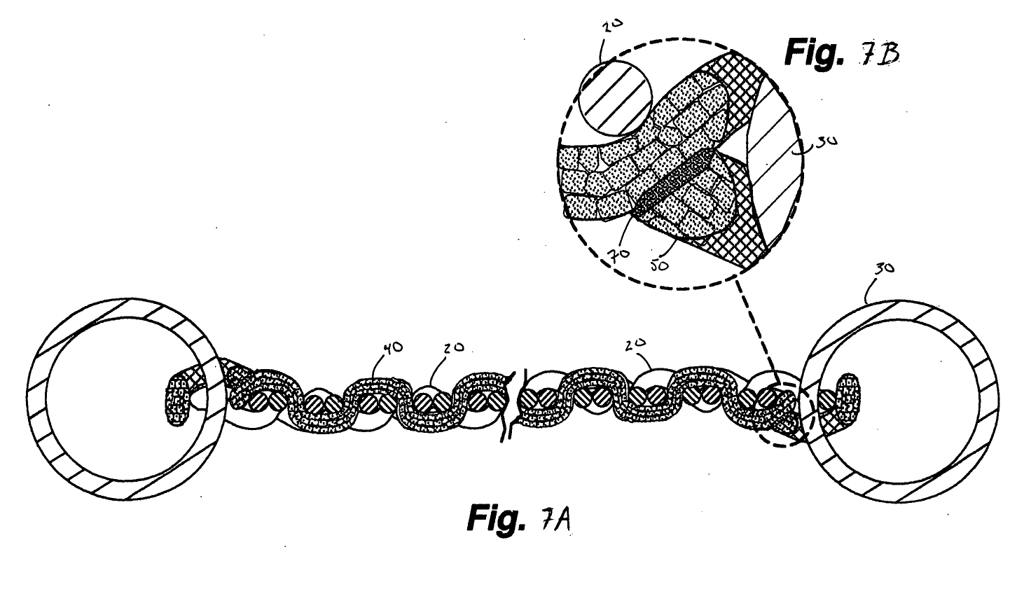

As yet another option, the fabric 40 may be looped about and glued, sealed, or otherwise attached such that the end 50 abuts an exterior of the fabric at some attachment point 70 along the length of the chain 10, as shown in FIGS. 7A and 7B. This structure is typically used to maintain disposition of the fabric 40 within the chain 10 when weaving the end 50 of the fabric into the fabric body is impractical or undesired. The fabric may also be split into strands in order to pass over certain chain links 20 or the hoop 30, and the strands glued, tied, or otherwise affixed to one another to maintain the relationship between fabric 40 and chain 10.

It should be noted that the fabric 10 may be imprinted with or otherwise display a pattern. If the fabric 10 is woven of multiple strands in a rope-like fashion, for example, each strand may have a color or pattern thereon contributing to an overall pattern of the chain 10. The chain's pattern may be any desired graphic, picture, or design desired, and typically provides the embodiment with an aesthetic appeal.

Although the present invention has been described with respect to particular embodiments, it should be understood that a number of variations will be apparent to those of ordinary skill in the art upon reading the present disclosure. Accordingly, the proper scope of the invention is defined by the appended claims.

We claim:

1. An animal restraint device, comprising:
a chain comprising at least a first link and a second link; and
a fabric woven between the at least two links.

2. The animal restraint device of claim 1, wherein the fabric comprises a set of strands woven together.

3. The animal restraint device of claim 1, further comprising a first hoop disposed at a first end of the chain.

4. The animal restraint device of claim 3, further comprising a second hoop disposed at a second end of the chain.

5. The animal restraint device of claim 4, wherein:
the second end of the chain comprises the second link; and
the fabric is looped about one of the group comprising the second link and the second hoop.

6. The animal restraint device of claim 5, wherein an end of the fabric is affixed to a portion of the fabric to form the loop.

7. The animal restraint device of claim 6, wherein the end of the fabric is interwoven with the portion of the fabric.

8. The animal restraint device of claim 6, wherein the end of the fabric is sealed to an exterior of the portion of the fabric.

9. The animal restraint device of claim 6, further comprising a leash operatively attached to the chain.

10. The animal restraint device of claim 9, wherein the leash is operatively attached to the first link.

11. The animal restraint device of claim 6, further comprising a second hoop affixed to the first link.

12. The animal restraint device of claim 1, wherein the fabric comprises an animal hide.

13. The animal restraint device of claim 1, further comprising a pattern disposed on an exterior surface of the fabric.

14. The animal restraint device of claim 1, wherein:
the chain further comprises a third link and a fourth link;
the first link defines a first interior aperture;
the second link defines a second interior aperture;
the third link defines a third interior aperture;
the fourth link defines a fourth interior aperture;
the third link is affixed to the second link;
the fourth link is affixed to the third link and
the fabric passes through each of the first, second, third and fourth apertures.

15. A method for constructing an animal restraint device, comprising:
providing a chain having at least a first and a second link; and
weaving a fabric between the first and second links.

16. The method of claim 15, wherein:
the fabric passes through an aperture defined in the first link; and
the fabric passes through an aperture defined in the second link.

17. The method of claim 15, further comprising providing a hoop attached to the first link.

18. The method of claim 17, further comprising:
passing an end of the fabric around the hoop; and
affixing the end of the fabric to a portion of the fabric, the portion of the fabric other than the end of the fabric.

19. The method of claim 18, further comprising operationally connecting a leash to the hoop.

20. An apparatus, comprising:
a chain having a first end and a second end, comprising:
a first link defining a first interior aperture;
a second link defining a second interior aperture;
a third link defining a third interior aperture;
a fabric woven through the first, second, and third interior apertures, the fabric comprising at least two strands woven together;
a first hoop disposed at the first end;
a second hoop disposed at the second end; and
a leash attached to the first hoop.
